(19) United States
(12) Patent Application Publication
(10) Pub. No.: US 2016/0114297 A1
(43) Pub. Date: Apr. 28, 2016

(54) CHILLED BEVERAGE DISPENSING MACHINE

(71) Applicants: Oscar Perez, Sunrise, FL (US); Guillermo Jose Leon, Southwest Ranches, FL (US)

(72) Inventors: Oscar Perez, Sunrise, FL (US); Guillermo Jose Leon, Southwest Ranches, FL (US)

(21) Appl. No.: 14/920,837

(22) Filed: Oct. 22, 2015

Related U.S. Application Data
(60) Provisional application No. 62/067,422, filed on Oct. 22, 2014.

(51) Int. Cl. B01F 5/08; F25B 39/00; B01F 15/02

(52) U.S. Cl. CPC B01F 5/08; B01F 15/0243; B01F 15/0235; F25B 39/00; B01F 2015/0204; B01F 2215/0022; F25B 39/02

(57) ABSTRACT

A cold beverage dispensing system for preparing a cold beverage from cold water and a beverage powder. Water is chilled and introduced to a mixing tube or beverage blender. Powder is simultaneously introduced to the beverage blender or mixing tube at a predetermined rate according to preset parameters. A mixing device in the mixing tube dissolves the powder into the cold water as it traverses the mixing tube. A nozzle dispenses the cold beverage into a cup or other receptacle. Additional ingredients such as caffeine and vitamins may also be injected into the beverage prior to it being dispensed. The water is chilled by a water chiller that forms a sheet of ice over its interior walls to more efficiently store and transfer cold.

### CROSS-REFERENCE TO RELATED APPLICATIONS

This application is claims priority to U.S. Provisional Application Ser. No. 62/067,422 filed on Oct. 22, 2015, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

1. Field of Endeavor

The present invention relates to an apparatus and system for mixing and dispensing cold beverages made from a powder. More particularly, the invention relates to an apparatus and system for automated mixing a dry powder with water cold beverage to provide and dispense a cold beverage substantially fee of clumps.

2. Background Information

Prior art beverage mixing devices are poorly designed to work with powders for making a beverage, and are often jammed or frustrated by the forming clumps and cakes. A beverage powders are usually hydroscopic and/or hydrophilic and thus readily absorb moisture. Prior art beverage mixing devices typically used hot water and, as a result, produced steam or water vapor within the beverage apparatus. The entrapped water vapor is absorbed by the hydrophilic powder, resulting in caking of the powder. The caked or clumped powder tends to clog the hoppers and impede dispensing of the powder. As a result of the impeded powder dispensing, the beverage produced by such apparatus was inconsistent. Furthermore, the powder clumping problem required additional maintenance in order to break up the clumps and clear any dispensing tubes.

Another problem encountered with prior art powdered beverage dispensing mixing apparatus is a tendency to produce inconsistent beverages from the powdered beverage substance. One of the problems causing inconsistent beverages is the inability to thoroughly and effectively mix or blend the powder with a desired quantity of water to produce the resulting reconstituted beverage. Some prior art devices attempt to reconstitute beverage powders, for example hot cocoa mix powder, using only water forces to mix the powder with the water. In other words, water was injected into a mixing chamber and mixed with the beverage powder therein to produce the beverage. If variables associated with the water were altered, such as injection speed, the powder may not thoroughly mix and, as a result, produce an inconsistent beverage.

The prior art devices also fail to provide a reliable continuous flow mixing process. Powders are mixed with water in a mixing chamber and beverages are prepared in batches. This may be time consuming and therefore inconvenient. Other devices only prepare room temperature or hot beverages. Other devices use a syrup rather than a dry powder. While this overcomes the difficulties resulting from clumping of a dry powder, it introduces additional problems.

Maintaining a preferred temperature is another problem often encountered with beverage dispensing systems that incorporate multiple ingredients mixed together. Often ingredients are stored at different temperatures and a resulting product is often dispensed at a temperature between the storage temperatures of the respective ingredients. When cold water is mixed with powders, other liquids or other materials, the temperature of the water will increase. This may be particularly problematic if the dissolution of the ingredients is an exothermic reaction.

In view of the foregoing, there is a need to provide an automated device for continuous flow preparation of cold beverages using cold water and a powder.

### BRIEF SUMMARY OF THE INVENTION

In one embodiment, an apparatus for automated continuous flow production of a cold beverage incorporates a cold water reservoir in fluid communication with a reservoir pump. The reservoir pump is in fluid communication with a mixing tube. One or more hoppers contain one or more beverage powders. Each hopper is in fluid communication with the mixing tube by means of a conduit. The mixing tube receives cold water at a first end. An inlet port in fluid communication with the one or more conduits provides powder to the mixing tube. An internal mixing device blends the powder and cold water such that the powder adequately dissolves. The mixing tube has a second end having a nozzle for dispensing the beverage into a cup.

In another embodiment, an apparatus for automated continuous flow production of a cold beverage uses hoppers that each have an auger dispensing device for extruding powder into the one or more conduits.

It is therefore an object of the present invention to provide a device and system for producing a cold beverage from cold water and a powder in a continuous flow manner.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a mixing device in accordance with the principles of the invention;

FIG. 2 is a diagram of an alternative embodiment of a mixing device in accordance with the principles of the invention;

FIG. 3 is a diagram of an alternative embodiment of a mixing device in accordance with the principles of the invention;

FIG. 4 is a diagram of an alternative embodiment of a mixing device in accordance with the principles of the invention;

FIG. 5 is a diagram of a cold beverage dispensing system in accordance with the principles of the invention;

FIG. 6 is a perspective view of a water chiller in accordance with the principles of the invention;

FIG. 7 is an exploded side view of a water chiller in accordance with the principles of the invention;

FIG. 8 is a cutaway view of the interior of a water chiller in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Disclosed are devices and systems for an automated, continuous flow mixing system for preparing a cold beverage using cold water and a powder, without use of a mixing chamber or a batch process.

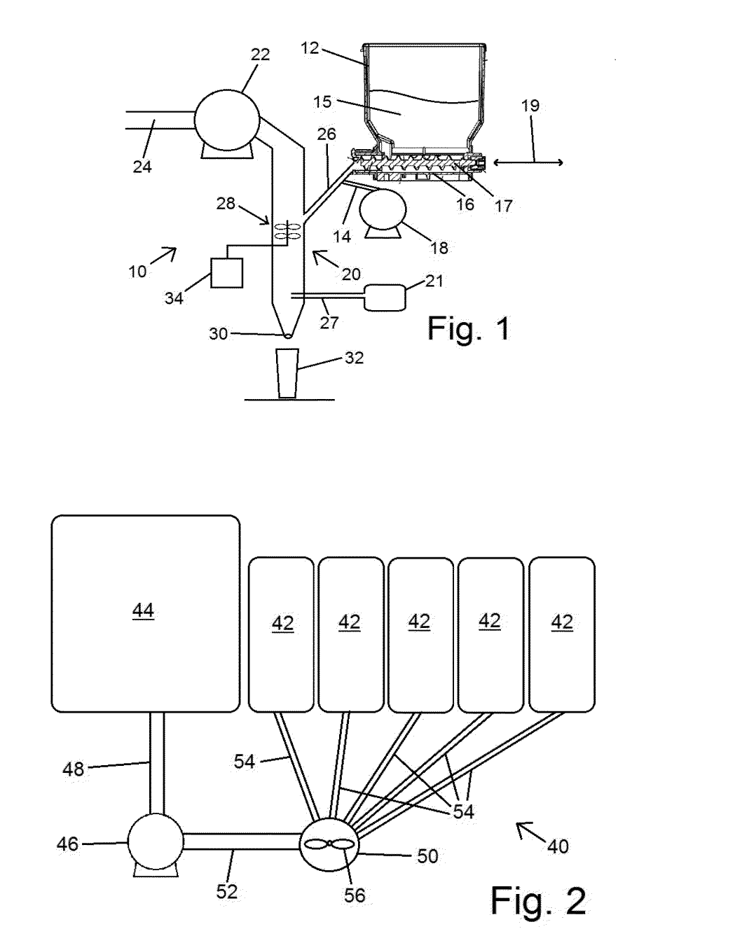

FIG. 1 shows an automated cold beverage mixing system 10 in accordance with the principles of the invention. The mixing system 10 includes a powder hopper 12 used for storing beverage powder 15. A screw dispenser 17 located in Auger chamber 16 at the bottom of the pin 12 rotates about longitudinal axis 19 in order to deliver beverage powder 15 into powder conduit 26. A pump 18 may optionally supply air or water into conduit 26 through hose 14. Introduction of air or water into conduit 26 by pump 18, may drive powder through conduit 26 to ensure that it reaches mixing tube 20 via an inlet port.

Pipe 24 supplies cold water to pump 22, which then forces water through mixing tube 20 such that it engages and mixes with beverage powder 15 as it exits from conduit 26. A mixing device 28 located within mixing tube 20 may be actuated by a motor 34. Mixing device 28 may operate at high speed to ensure complete mixing and dissolution of the beverage powder 15 into the water supplied by pump 22. The water supplied by pump 22 may be extremely cold. As a result, it is more difficult for a beverage powder to dissolve into it. It may therefore be desirable to have a mixing device 28 capable of imparting sufficient kinetic energy into the mixture to ensure that the powder 15 dissolves. The amount of powder 15 fed into the mixing to 20 may be regulated by the speed at which screw dispenser 17 is rotated and by the amount of air or water supplied by pump 18.

Nozzle 30 may be located at the distal end of mixing tube 20. A cup 32 may be placed underneath the nozzle 30 to receive a mixed cold beverage. Because the nozzle 30 is narrower than the mixing tube 20, it may compress the mixed cold beverage prior to dispensing. This may result in additional agitation of the mixed cold beverage and order to further facilitate complete dissolution of the powder into the water.

An additive container 21 may include one or more compositions of matter that may be optionally added to the beverage through injection tube 27. The composition may be moved through injection tube 27 by means of a pump or other action. In this embodiment, only one additive container 21 and injection tube 27 are shown. A mixing device in accordance with the principles of the invention may comprise a plurality of attitude containers and corresponding injection tubes. The additive containers may include a variety of materials, which may be desirable to be added to a beverage in small quantities. For example, caffeine, ginseng, creatine, vitamins or other materials commonly found in beverages may be added to a beverage created by the mixing device in accordance with the principles of the invention.

The water supplied to pump 22 by pipe 24 may be purified by means of a filter or other device that may be included as part of the mixing system. It may also be chilled using any conventional refrigeration mechanism such that it is already very cold, between 32° and 42° F. The pump 22 may impart a low amount of incidental energy to the water flowing through it, but not enough to substantially alter the temperature of the water. The mixing and dissolving of the powder 15 into the water, including the action of the mixing device 28 may also be similarly insufficient to sufficiently change the temperature of the water. As a result, the beverage dispensed into 32 may be very cold, as is generally desirable. The mixing system 10 thus provides a continuous flow mixing system for providing a cold beverage resulting from mixture of a powder with cold water.

To ensure adequate mixing, each component may be carefully regulated. It may be important to precisely meter or dispense the beverage powder 15 into the mixing two. Any suitable method may be used to ensure precise metering. The flow rate of water entering the mixing tube 20 and the speed of mixing device 28 may also be precisely calibrated to ensure adequate mixing. The parameters under which the mixing device 28, the introduction of water and the introduction powder may be predetermined for different types of powder.

FIG. 2 shows an alternative embodiment of a cold beverage mixing system 40. Mixing system 40 includes five separate powder hoppers 42 and a cold water reservoir 44. Cold water reservoir 44 may be chilled using any refrigerating device suitable for maintaining a reservoir of water between 32 and 42° F. Pipe 48 feeds cold water from reservoir 44 into pump 46, which may then pump cold water through pipe 52 and into mixing tube 50. Conduits 54 may connect each of hoppers 42 to the mixing tube 50. Each of hoppers 42 may include an auger system or other similar device for extruding the powder within them into conduits 54. In this embodiment, there are no air or water pumps to facilitate powder traveling through conduits 54. Those skilled in the art will appreciate that more or fewer hoppers 42 may be present. Similarly, hoppers 42 and conduits 54 may be modified to include a pump to facilitate moving powder from the bends into the mixing tube.

The embodiment shown in FIG. 2 utilizes a propeller type mixing device 56 similar to the mixing device 28 shown in FIG. 1. However, other suitable mixing devices may be used.

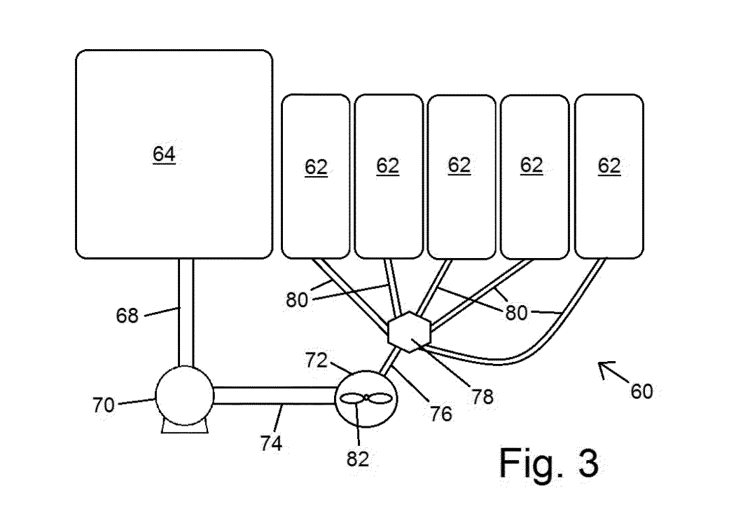

FIG. 3 shows another alternative embodiment of a cold beverage mixing device 60. Mixing device 60 includes five hoppers 62 and a reservoir 64. Reservoir 64 is in fluid connection with pump 70, providing chilled water through pipe 68. Pump 70 directs cold water through pipe 74 and into mixing to 72. In this embodiment, each hopper 62 includes an auger or similar extruding device for feeding powder into their respective conduit 80. Each conduit 80 is in communication with a powder hub 78. The powder hub 72 may receive one or more powders from one or more hoppers 62. Powder travels from powder hub 78 through dispensing tube 76 and into the mixing to 72. One or more air or water pumps may be attached to any of the conduit 80, the powder hub 78 or the dispensing tube 76.

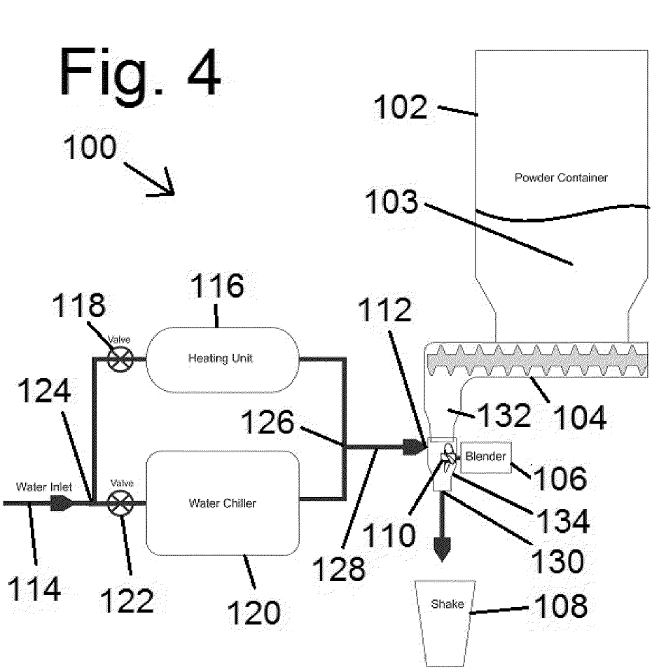

FIG. 4 shows an alternative embodiment of a cold beverage mixing device 100. The mixing device 100 includes a hopper 102 containing a dry beverage powder, 103. An auger extruding system 104 dispenses powder into a vertical and somewhat tapered funnel 132. Powder 103 may fall down the funnel 132 and into a mixing to 134. A mixing device 110 may be located in the mixing two 134 and may be powered by a motor 106. In this embodiment, the propeller mixer 110 has a longitudinal axis about which it rotates that is perpendicular to the direction of flow of the powder and the water. Those skilled in the art will appreciate that there are a variety of different types of mixing devices suitable for the purposes of the invention.

Water may be supplied to the device through water inlet 114. Water inlet 114 may split into two separate streams at a joint 124. Which of the streams a water flows down may depend upon valves 118 and 122. Opening valve 118, may cause water to flow into heating unit 116, where it may be heated. Opening valve 122 may cause water to flow into water chiller 120 where it may be cooled. Water from either or both of heating unit 116 and water chiller 120 may travel through a connecting joint 126 and into water supply pipe 128. Water from supply pipe 128 may enter the mixing tube 134 through inlet port 112 that may be substantially perpendicular to the direction of flow of powder 103 from the final 132 and into mixing two 134. By supplying a powder 103 having a direction of flow perpendicular to the direction of flow of supplied water, and both of these directions of flow being skew to the axis of rotation of the mixing device 110 may facilitate rapid and complete dissolution of the powder into the water.

The water and powder may be mixed such that the powder substantially dissolves in the chilled water supplied to the mixing tube 134. The flow rate of the powder may be predetermined by the flow rate of the water. The speed at which the mixing device 110 operates may also be predetermined according to the type of powder used. The bottom of the mixing to 134 tapers downward to form a nozzle 130. A cup 108 positioned beneath the nozzle 130 may receive the blended cold beverage.

The device is disclosed herein may be particularly suitable for use in vending machines. Because the dry beverage powder may be stored in hoppers as a dry powder instead of a mix, syrup, or concentrate, it's shelf-life may be substantially extended and risk of contamination minimized. Additionally, use of powder instead of a liquid-based premix substantially reduces the weight of the materials placed in the hoppers. The dry powder may last one to several months or more.

Some of the embodiments disclosed in herein contemplate the use of a water reservoir, wherein all of the stored water is chilled. It may be desirable to utilize a system as shown in FIG. 4, where water is not chilled until a beverage is being made. In this manner, only a small amount of water is cooled and only when it is required. This may substantially reduce the amounts of energy required, and thereby increase efficiency of a vending machine utilizing the devices and systems of the present invention.

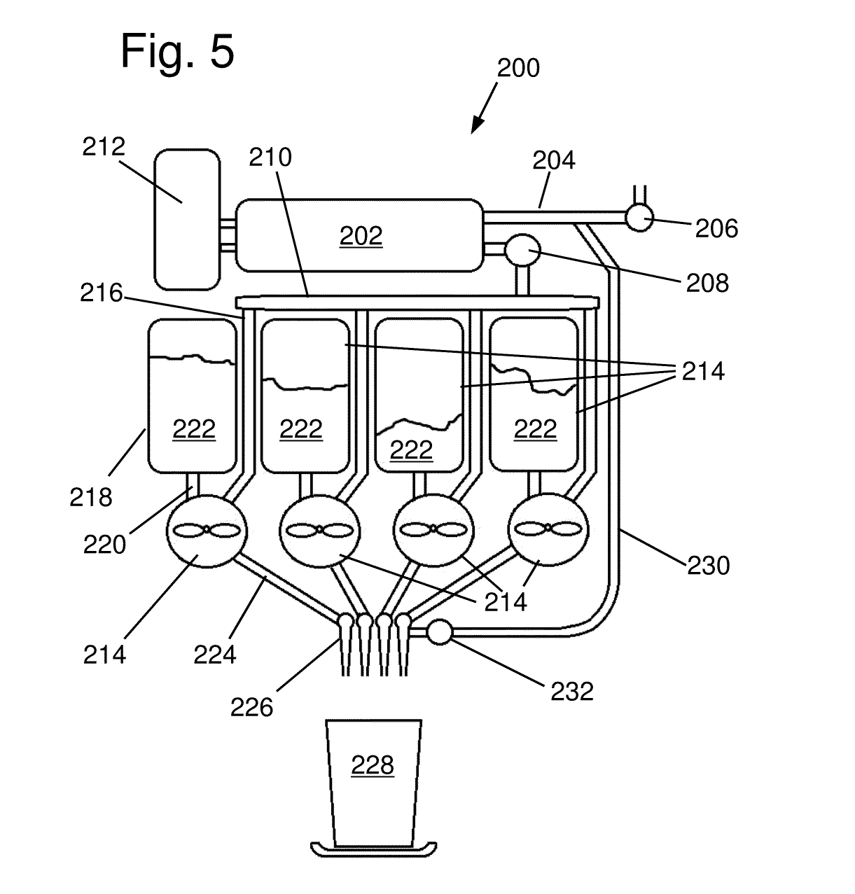

FIG. 5 shows a schematic diagram of an alternative embodiment of a cold beverage dispensing system 200 in accordance with the principles of the invention. A cold beverage dispensing system 200 may include a water chiller 202 fed water through inlet 204 and valve 206. The water chiller may also include a condenser 212. Chilled water may exit the water chiller 202 by means of a valve and/or pump 208 and inter-a manifold 210. From the manifold 210, chilled water may be supplied via conduits 216 to one or more discreet blenders 214. Each blender 214 may be in communication with a separate, discrete hopper 218 by a channel 220. Each individual beverage powder hopper 218 may contain a different powder 222 for making different beverages. The channels 220 may include an auger or other device for providing a predetermined, measured amount to the blender 214. When the beverage powder 222 is introduced into the blender 214 simultaneously with chilled water through one of the conduits 216, it may mix the powder with the chilled water until blended into a beverage. The newly formed beverage may then travel through dispensing conduit 224, out of nozzle 226 and into a cup 228.

In this embodiment, there are four separate beverage powder hoppers 214, each containing a different powder 222 and in communication with its own separate blender 214. Each separate blender may also receive water via its own separate conduit 216 in communication with the manifold 210. By providing individual blenders 214, conduits 216, hoppers 218, channels 220, dispensing conduit 224 and nozzle's 226 for each different type of powder, cross-contamination between the different powders may be avoided. This may improve the quality of the beverages.

The cold beverage dispensing system 200 also includes a recirculating system 230 that may include a valve and/or pump 232. The recirculating system 230 may be in communication with each of the nozzles 226 and/or each of the dispensing conduits 224. Because only the water inside the water chiller 202 is cold, a dispensed beverage may include water exposed to several room temperature components such as the manifold to 10, conduits to 16, blenders 214 and dispensing conduits 224. To minimize this effect and to produce beverages as cold as possible, the cold beverage dispensing system 200 may circulate chilled water from the water chiller 202, through the pump 208, the manifold 210, one or more conduits 216, one or more blenders 214, one or more dispensing conduits 224 and optionally one or more nozzles 226. Rather than waste this water, it may be recycled through the recirculating system 230 by means of a pump 232 or otherwise. As a result, the path of chilled water and cold beverage through the system will be pre-cooled by the circulated cold water. This provides an even colder dispensed beverage without the need to refrigerate the entire cold beverage dispensing system 200.

In some embodiments, the cold beverage dispensing system 200 may be incorporated into a vending machine or similar device. The system may optionally be programmed to begin pre-cooling the system by circulating cold water the moment a control pad, such as for example a touchscreen or various selection buttons are engaged or actuated whether or not an order is actually placed in payment made. While this may occasionally result in unnecessary precooling, the waster cost provided by unnecessary precoolings may be minimal.

FIG. 5 is a schematic representation and those skilled in the art will appreciate that there may be several valves and/or pumps or other mechanisms commonly used in fluid systems to facilitate operation of the system 200. An operation, water is supplied to the water chiller 202 through the inlet 204. The supply of the water may be regulated by a pump or other device 206. The water chiller 202 may then supply cold water to the manifold 210 through pump 208 that may optionally include a valve or simply be a valve. The manifold 210 may supply cold water to one or more conduits 216. Valves between the manifold 210 in the conduits 216 may regulate which conduits receive water from the manifold.

Chilled water then enters a blender 214 to which a beverage powder 222 may be simultaneously supplied by the channel 220. There may be a valve regulating flow from channel 220 into the blender 214. When the system is pre-cooled, the channel 220 may optionally be sealed off from the blender 214 to prevent water from back flowing up the channel 220. Flow from the blender 214 through the dispensing conduit 224 and out the nozzles 226 may also be regulated by pumps and/or valves. When the system 200 is actuated by an operator, it may supply chilled water into only one blender 214. Optionally, the system 200 may be configured to allow an operator to modulate or attenuate the flow of water and powder into various blenders. In other words, an operator may request a beverage comprised 25% of a first powder and 75% of a second powder. The system may then regulate the amount of powder and water dispensed into blenders for the selected beverage types and then dispensed out of their respective nozzles to provide a mixed chilled beverage. They may also be desirable to utilize insulation around one or more of the components through which water travels. This insulation in conjunction with the pre-cooling by circulating chilled water through the system prior to use may ensure that a dispensed beverage is as cold as is practicable.

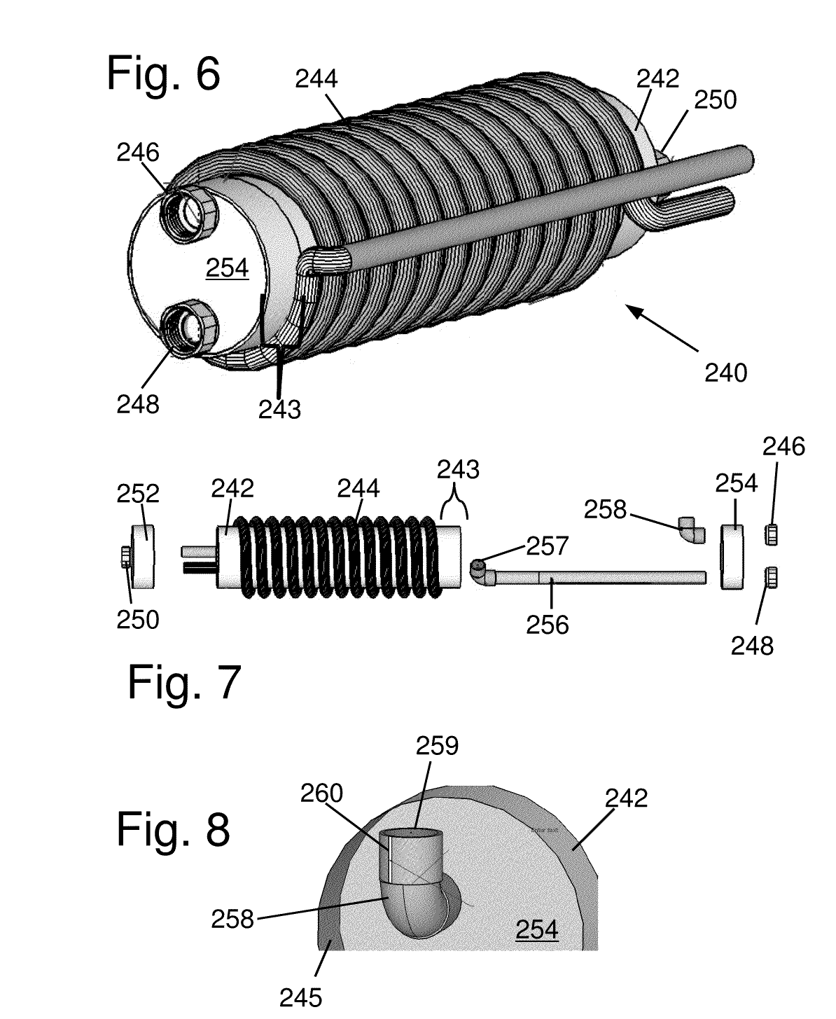

FIG. 6 shows a water chiller 240 for use in accordance with the principles of the invention. The water chiller 240 may be suitable for use as the water chiller 202 of FIG. 5. Water chiller 240 may have a substantially cylindrical body 242 surrounded by an evaporator coil 244. One end of the water chiller body 242 may have a section not covered by the evaporator coil and having a water inlet 248 and a water outlet 246. In this embodiments, the inlet 248 is below the outlet 246. The opposite end of the body 242 may include a sensor 250.

FIG. 7 shows an exploded side view of the water chiller 240. The cylindrical body 242 is sealed on each end by circular end caps 252 and 254. End cap 252 includes a sensor 250 that may monitor the internal water temperature of the chiller 240. Optionally, the sensor 250 may monitor the amount of ice accumulated on the interior wall of the body 242. End cap 254 may have a water inlet 248 connected to a water inlet pipe 256 ending in an elbow 257. The elbow 257 may be angled such that water entering the body 242 from the inlet pipe 256 enters flowing in a direction tangent to the inner wall. As a result, entering water creates a circular and spiraling convection current that may maximize incoming waters contact with the walls of the body 242.

Similarly, the water outlet 246 may be connected to an elbow 258. The elbow 258 may be positioned such that the opening at the distal end 259 of the elbow 258 is facing upward as shown in FIG. 8. This may allow the water outlet 246 two only remove water that rises above the distal end of the elbow. This may maximize and/or regulate the amount of water held within the water chiller. Optionally, a narrow slit to 60 may run along the side of the elbow extending from the distal end 259 of the elbow and partway down the length of the elbow.

In use, the water chiller 240 may be used to supply chilled water at or near freezing. One method of operating the water chiller 240 includes using the evaporator coil to bring the temperature of body 242 to below freezing. As a result, a sheet of ice may form about the inner wall 245 inside the water chiller.

The water chiller may be designed to lower the temperature of the water to the coolest point with minimum freezing by allowing a narrow layer of water to freeze on the wall of the main 3″ pipe. This increases the cooling capacity of the evaporator. To convert ice into water takes far more heat than to increase the water temperature 1 degree. The specific heat capacity of water=4.2 KJ/(KgK). The latent heat of melting=334 KJ/Kg. This means that to melt 1 gr. of water requires the same energy than to cool 80 gr. of water one degree centigrade (kelvin). According to these calculations; having a layer of ice inside the pipe increases by far the cooling volume capacity of the container. Therefore, the wait time to cool warm water flowing through the system is reduced significantly.

If more ice than desired accumulates along the inner wall 245, it may block or partially block the distal end 259 of the elbow 258. By providing a slit to 60, water may still exit the water chiller 240, out be it at a slower rate. Chilled water may then enter the water chiller that may assist in removing excess ice. In addition, the water exit elbow 258 may be located within a region 243 of the body 242 that is not in contact with the evaporator coil 244. Because the portion of the body 242 immediately surrounding the exit elbow 258 is not directly cooled by an evaporator coil, the likelihood that too much ice will accumulate near the exit elbow 258 and clog the chiller is minimized.

It may be desirable for the water chiller 244 to be relatively small, for example having a 3 inch diameter. The small size may reduce the amount of time necessary to cool water inside the chiller.

The layer of ice generated on the perimeter of a 3″ body 242 can be measured by an ice sensor or by measuring the wall temperature of the water and keeping the evaporator coil operating for a set amount of time. If a layer of ice is not desired inside the evaporator, the temperature of the water can be set a value just above zero centigrade (32 F).

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. An apparatus for automated continuous flow production of a cold beverage comprising:
a cold water reservoir;
a reservoir pump in fluid communication with the cold water reservoir;
one or more hoppers containing one or more beverage powders;
one or more powder conduits in fluid communication with each of the one or more hoppers;
a mixing tube having a first end receiving water supplied by the reservoir pump, an inlet port in fluid communication with the one or more conduits, an internal mixing device and a second end having a nozzle for dispensing into a cup.

2. The apparatus for automated continuous flow production of a cold beverage of claim 1 wherein the hoppers include an auger dispensing device for extruding powder into the one or more conduits.

3. A cold beverage dispensing system comprising:
a water chiller receiving water from a water inlet;
at least one beverage powder hopper a beverage powder;
at least one cold beverage blender in fluid communication with the water chiller, the beverage powder hopper and a dispensing conduit;
a nozzle at the end of the dispensing conduit;
a recirculating system providing fluid communication and fluid flow from the dispensing conduit to the water inlet.

4. The cold beverage dispensing system of claim 3 further comprising a plurality of beverage powder hoppers each in fluid communication with a different cold beverage blender, wherein each cold beverage blender is in communication with a separate dispensing conduit and each dispensing conduit has a separate nozzle for dispensing a cold beverage.

5. The cold beverage dispensing system of claim 4 wherein the water chiller includes a cylindrical body surrounded by an evaporator coil.
